(19) United States
(12) Patent Application Publication
(10) Pub. No.: US 2025/0389607 A1
(43) Pub. Date: Dec. 25, 2025

(54) LOW MARKING GRIPPER FOR A HYDROSTATIC TEST AND ISOLATION PLUG

(71) Applicant: EST Group, Inc., Hatfield, PA (US)

(72) Inventors: Alex Kotlyar, Jamison, PA (US); Ka'ren Sarkissian, Langhorne, PA (US); Danko Kobziar, Lansdale, PA (US); Lucas Gregory, Southampton, PA (US)

(21) Appl. No.: 19/246,573

(22) Filed: Jun. 23, 2025

Related U.S. Application Data
(60) Provisional application No. 63/663,166, filed on Jun. 23, 2024.

(51) Int. Cl. G01M 3/02; F16L 55/132

(52) U.S. Cl. CPC G01M 3/022; F16L 55/132

(57) ABSTRACT

A low-marking gripper for a hydrostatic test or isolation plug is provided. The gripper includes at least one gripper segment having a pipe or tube confronting surface with a plurality of separate rows of gripper teeth longitudinally-spaced apart on the surface. Each of the separate rows of gripper teeth comprising an alternating array of individual tips and gaps such that each row is serrated along its length. Each of the teeth has a height of 0.005 inch or less and a tip having an upper surface with an area of less than 0.0002 inch². The gripper segment includes at least one longitudinal-extending slot extending therethrough to provide flexibility.

### CROSS REFERENCE TO RELATED APPLICATIONS

This application claims the benefit under 35 USC § 119 (e) of U.S. Provisional Patent Application No. 63/663,166, filed Jun. 23, 2014.

### BACKGROUND

The present invention relates to plugs for gripping and forming fluid-tight seals with inner or outer peripheries of pipes, pipelines, tubes, pressure vessels and the like. More specifically, the present invention relates to components of hydrostatic test and pipeline isolation plugs enabling the plug to grip and/or bite into the inner or outer diameter of pipe or tube walls and/or to withstand differential pressure across the seal.

By way of example, Curtiss-Wright EST Group manufactures and sells a brand of test plugs, GRIPTIGHT® Test Plugs, to facilitate pipe hydrotesting. The plugs, also referred to as mechanical pipe test plugs, are actuated by tightening a series of rim nuts around the periphery of the pipe plug, sealing it for protection. Hydro Test Plugs, also known as hydrostatic testing plugs, are typically suitable for high pressure testing up to about 15,000 psi and also for pneumatic testing.

In recent years, pipes used in the industry are being produced from a variety of different materials encompassing high-alloys, chrome-alloys, glass reinforced epoxy (GRE), fiberglass reinformed plastic (FRP), and others. To enhance the performance of test plugs for use with these robust and hard pipe materials, Applicant of the present application introduced test plugs having grippers as disclosed in U.S. Pat. No. 9,664,588 B2 issued to Kotlyar et al, and which are sold under the brand name GTMAX® test plugs. These plugs provide improved performance and permit such plugs to be used in applications with much harder pipes. In addition, these plugs are able to be used at increased test pressure, provide improved installation performance, and greatly enhanced user safety.

The expanding liquefied natural gas (LNG) industry has increasingly stringent requirements for pipe conditions, including pipe inner diameter (ID) marking. This is due to the potential impact on safety, performance, regulatory compliance, maintenance, and material selection. Addressing these imperfections is crucial for the safe and efficient operation of LNG facilities. Consequently, test plugs that leave minimal or no gripping marks and that eliminate the need to cut away damaged parts of pipes after testing are desired.

Inherently, the grippers of test plugs are designed to bite into the pipe wall to secure the plug during testing. These grippers must provide sufficient resistance to withstand the total force accumulated by pressure. In some instances (conditions with large pipes and high pressure), this force can equate to millions of pounds. Therefore, while some gripping marks are inevitable, the performance needs to be significantly enhanced to meet the stringent requirements of the LNG market.

### BRIEF DESCRIPTION OF THE DRAWINGS

The foregoing and other objects, features and advantages of the embodiments disclosed herein should become apparent from the following description when taken in conjunction with the accompanying drawings.

FIG. 1 is a perspective view of a plug according to an embodiment.

FIG. 2 is another perspective view of the plug of FIG. 1.

FIG. 3 is a magnified perspective view of a part of a gripper segment of the plug of FIG. 1 according to an embodiment.

FIG. 4 is a perspective view of the gripper segment of the plug of FIG. 1 according to an embodiment.

FIG. 5 is a perspective view of a set of a gripper segments for a plug according to an embodiment.

FIG. 6 is an elevation view of a test plug according to an embodiment.

FIG. 7 is a cross-sectional view of a test plug positioned within a pipe according to an embodiment.

FIG. 8 is a perspective view of an inner diameter of a pipe having been subject to qualification testing with grease applied on pipe ID and grippers.

FIG. 9 is a perspective view of a test plug according to an embodiment.

FIG. 10 is a chart showing results of qualification testing with grease applied on pipe ID and grippers using a test plug according to an embodiment.

FIG. 11 is a chart showing results of qualification testing with grease applied on pipe ID and grippers using a test plug according to the prior art.

FIG. 12 is a perspective view of an inner diameter of a pipe having been subjected to qualification testing with grease applied on pipe ID and grippers using a test plug according to an embodiment.

FIG. 13 is a perspective view of an inner diameter of a pipe having been subjected to qualification testing with grease applied on pipe ID and grippers using a test plug according to the prior art.

### DETAILED DESCRIPTION

Embodiments disclosed herein are directed to components enabling a mechanical hydrostatic test or isolation plug to engage, frictionally engage, grip, bite, or make intimate contact with an inner diameter or outer diameter wall of a pipe or tube. Embodiments are also provided with respect to test and isolation plugs and assemblies of test and isolation plugs installed within the ends of pipes, tubes or the like. An objective of these components is to leave only a low amount of markings on the pipe as a result of testing.

As discussed above, some test and isolation plugs include one or more grippers capable of being urged radially outward or radially inward into engagement with an inner or outer peripheral wall of a pipe or tube to hold the plug in position during testing or isolation despite the use of high pipe pressurization or other forces that may be present. The grippers may be provided in a set, comprising one or more gripper segments, such as two, four, six or more separate segments or any even or odd number of gripper segments.

When provided in a set of separate grippers, the set may comprise a plurality of separate, aligned segments interconnected and biased inward or outward relative to a section of a test or isolation plug by a spring clip or the like. The set of segments may be closely aligned about or within the test plug; however, they may only be interconnected by a spring clip or the like to enable the gripper segments to expand outward or contract inward in a radial direction into engagement with an inner or outer diameter pipe or tube wall or to be placed in a non-engaging position permitting the plug to be inserted into or onto an open end of a pipe or tube or removed from the open end.

Before turning to embodiments of grippers, a discussion of an exemplary test plug is provided. It should be understood that grippers may be used on any type of plug including test plugs, isolation plugs, plugs having one seal, plugs having two or more longitudinally spaced seals, plugs having passages for pressurizing or depressurizing sections of a pipe, plugs having vents permitting vapor to be vented from within the pipe on an opposite side of the test or isolation plug, plugs that form seals against the inner diameter walls of pipes or tubes, and plugs that form seals against the outer diameter walls of pipes or tubes. It should also be understood that the grippers may be designed to engage substantially circular inner or outer diameters of pipe or tube walls as well as out-of-round pipe or tube walls, square pipe or tube walls, and any other shape of pipe or tube walls.

Merely for purposes of example, and not for purposes of limitation, an inner diameter test plug may be used to create a fluid-tight seal against an inner periphery of a pipe or tube adjacent its open end so that the pipe or tube may be subject to hydrostatic pressure testing. For instance, after the plug is installed, the pipe or tube may be pressurized with sufficient pressure to test for leaks or for any other purpose. The amount of pressure applied within the pipe depends on the design pressure rating of the pipe. The test plug must be able to create a fluid-tight seal that is able to withstand internal pipe working pressures and must remain in a fixed, non-sliding, stationary position within the pipe during testing and resist sliding, movement, blow-out or failure.

During installation, the plug is placed in a condition such that it is capable of being readily inserted into and through the open end of the pipe or tube without interference from the inner diameter of the pipe. The plug must also assume this position upon removal after testing has been completed. Likewise, for an outer diameter plug, the plug must be capable of being placed in a condition such that it is capable of being readily inserted onto and about the open end of the pipe or tube without interference from the outer diameter of the pipe or tube.

The plug includes a pair of end plates and means for causing the end plates to move together. Moving the plates toward each other ultimately causes the inner diameter of the pipe to be engaged by a set of gripping segments and a sealing element. Merely as an example, the end plates may be interconnected with a shaft, and the end of a threaded shaft may be engageable with a nut so that an installer can thread the nut further onto the shaft to cause relative displacement of the end plates toward one another.

A camming element or other mechanism may be located between the end plates to control the position of the gripper segments. For instance, according to one embodiment, the gripper segments may be slidably engageable relative to a frustoconical wall of the camming element on which the set of gripper segments is seated. Relative movement between the camming element and the set of gripper elements can force the set of grippers into positive engagement and intimate contact with the inner periphery of the pipe or tube such that the outer surface of the grippers contacts, grips, or bites into the pipe or tube wall thereby gripping the pipe or tube wall. It should be understood that the camming element provides one means for expanding a set of grippers and that various other different mechanisms could be used to expand a set of grippers into engagement with an inner diameter wall or contract the set of gripper into engagement with an outer diameter wall.

The set of grippers may include, for instance, four, annularly-aligned, separate, arc-shaped, segments interconnected and biased inwardly into close engagement with the camming element by a spring clip or the like. Of course, more or less segments can be utilized and the segments are not required to be arc-shaped or annularly-aligned. This shape and alignment ultimately depend upon the cross-sectional shape of the inner or outer wall of the pipe or tube to be gripped. For instance, the cross-sectional shape of the inner or outer wall could be square, multi-sided, oval, out-of round, or the like.

Each gripper segment may have an inner peripheral tapered wall for slidably engaging the proximal outer frustoconical wall of the camming element. Thus, when the end plates are moved toward one another, the grippers are forced up the slope of the outer frustoconical wall and thereby radially outward into gripping engagement with the inner periphery of the pipe. Of course, this provides only one means of expanding or contracting the set of grippers and any other means, such as levers, pivots, rotation or the like could be utilized.

In addition to the set of grippers, the plug also includes a seal element made of elastomeric material which is configured to be deformed into contact with the inner or outer peripheral wall of a pipe or tube. The resiliency of the seal element enables it to conform to a larger or smaller dimension while maintaining integrity or being a pressure boundary and then return to its as fabricated dimension after the pipe or tube is depressurized and the end plates are displaced away from one another. For instance, when the set of grippers are in gripping engagement with the inner periphery of the pipe or tube, further tightening of the nut will cause further movement of end plates toward each other to radially expand the seal element into sealing engagement with the inner periphery of the pipe or tube.

Of course, as discussed above, there are many different variations of test and isolation plugs. Some are adapted to test pipes or tubes downstream of the plug, and some are adapted to test the pipe or tube, connection, or flange segment adjacent the open end of the pipe or tube. Some isolation plugs include a pair of spaced apart sealing elements to isolate the end of the pipe or tube from vapors or other substances within the pipe or tube or to test welded connections or the like. Some include vents and other passages for pressurizing, depressurizing, or venting sections of pipe or tube relative to the plug. Still further, some plugs create a seal about the outer wall of a pipe or tube. It should be understood that the gripper design discussed below may be used on any type of test or isolation plug which is provides a pipe or tube wall gripping feature.

As test pressure requirements increase and pipes made of harder materials are required, larger amounts of force must be used to cause gripper segments to adequately grip pipe and tube walls. In addition, grippers providing performance and wear improvements relative to all types of pipes and tubes are desired, grippers of prolonged life are desired, grippers that create less continuous damage and deformation of pipe wall are desired, grippers that eliminate damage created by sliding is desired, and grippers that minimize or eliminate the need for pipe repair or rework after testing are desired.

For instance, the gripper segments may bite into a pipe or tube wall and permanently deform the pipe and form markings (i.e., in the same shape as continuous ridges or teeth of the grippers). At these locations, the pipe or tube material is pushed outward or inward creating ribs in the outer or inner diameter of the pipe wall. In most cases, these ribs are required to be removed after the completion of the test. Even though the deformation created by the gripper may not affect the performance of the pipe, it necessarily creates an undesired appearance and requires additional work and process time to remove. Alternatively, the test section (i.e., section deformed by the gripper biting into the pipe) of the pipe may need to be cut and removed which also results in additional process time and cost.

According to an embodiment, a low-marking gripper is provided that can accommodate LNG pipe requirements. The low-marking grippers ensure minimum pipe damage (marking depth is less than 0.005 inch (127 μm)) during and after use, while also ensuring reliability, performance and safety. Some of the unique features of the low-marking grippers are their profile, flexibility and consistency of teeth profile.

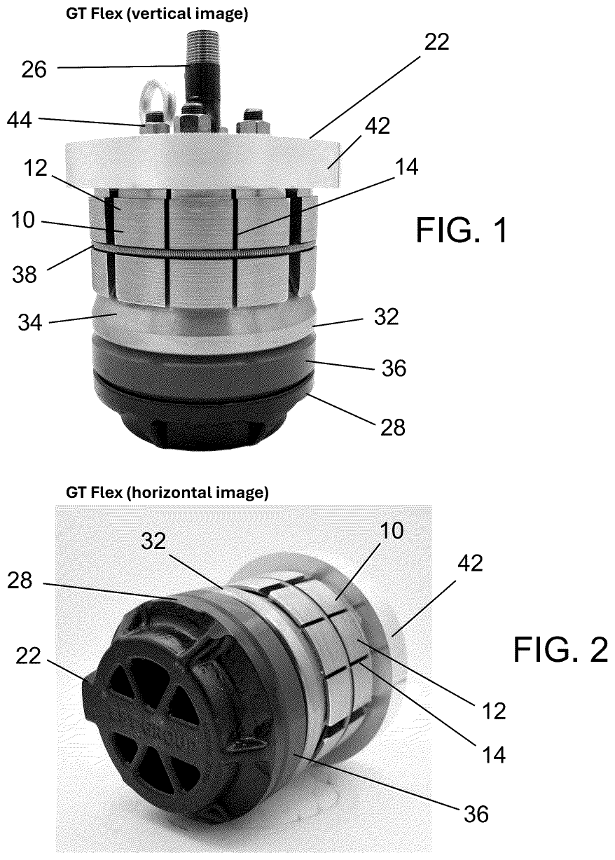

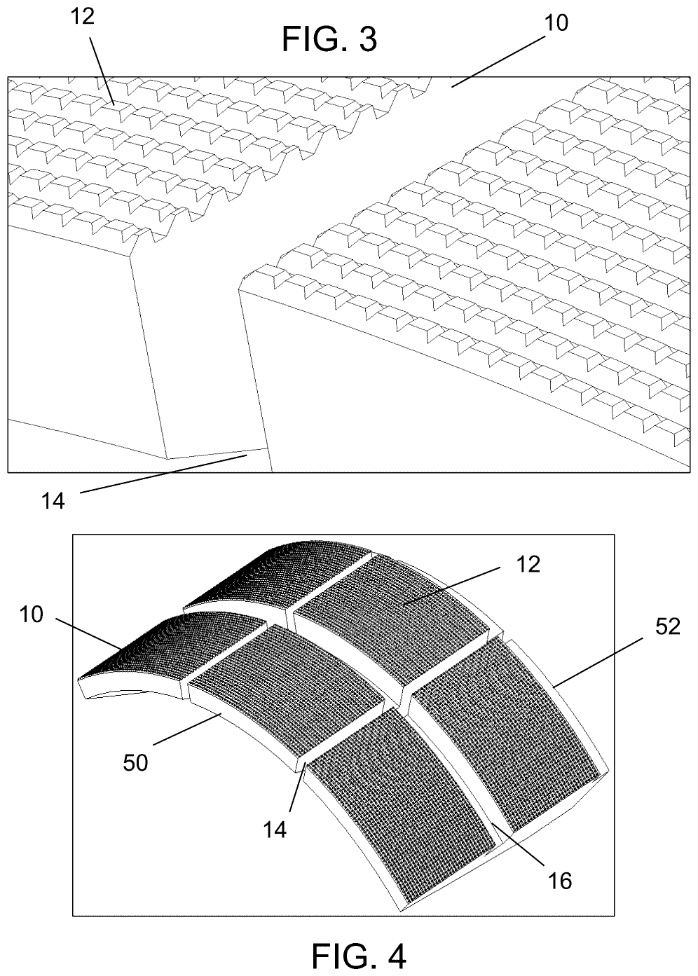

Plugs according to embodiments are shown in FIGS. 1, 2, 6, and 7 and include a set of low-marking grippers 10. The profile of a low-marking gripper 10 is best shown FIGS. 3 and 4 and ensures optimal performance and precise control over the production of gripping marks in walls of pipes and tubes. The gripper 10 includes a plurality of longitudinally-spaced circumferentially-extending rows of teeth 12. Each row of teeth 12 comprises an alternating array of individual teeth tips and gaps therebetween such that each row may be considered serrated along its length. To minimize gripping marks produced by the gripper 10, depth/height control is provided in the teeth profile. According to an embodiment, the depth/height of each of the teeth 12 is limited to 0.005 inch or less. However, to ensure sufficient grip, the number of teeth 12 may be increased proportionally.

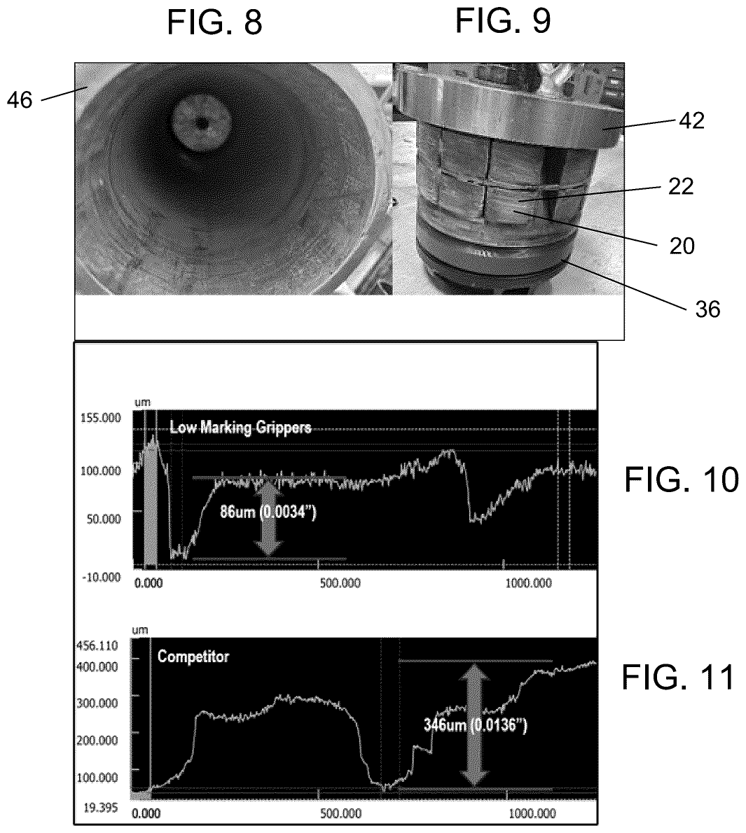

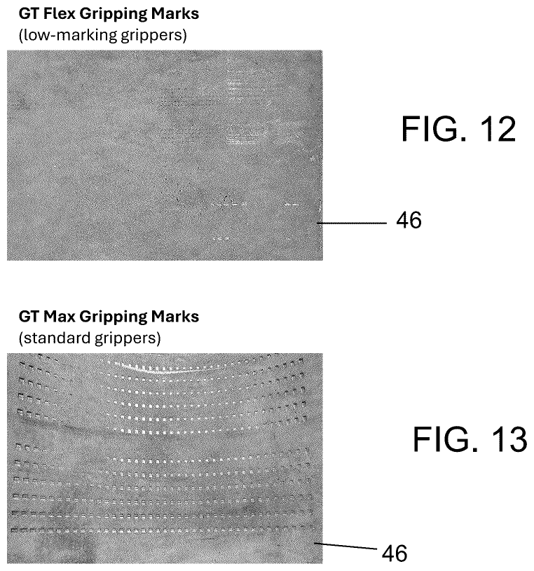

The teeth 12 of the low-marking gripper 10 resemble tiny needles, designed to pierce the pipe and leave only micro-marks. As an example, each of the teeth 12 may have a generally truncated pyramidal shape (i.e., each may have tapered walls having a flat tip). The flat tip of each tooth may have an area of less than about 0.0002 in² (about 5.08 μm²) to maximize “bite” effectiveness and improve safety. The marks produced by the low-marking gripper 10 are almost invisible during manual visual inspection with human eyesight. For instance, see FIGS. 8 and 12.

The adaptability of the low-marking grippers 10 is crucial to conform to the internal geometry of the pipe. Given that the height of each tooth 12 may only be 0.005 inch, it is essential for the geometry of the gripper 10 to align perfectly with the internal diameter of the pipe. Since the internal diameter of a pipe may not necessarily be strictly controlled, the gripper 10 must be provide with needed flexibility to adapt to varying internal diameters as the grippers are forced into engagement with the pipe. Accordingly, as best shown in FIGS. 3-5, axial slots 14 are provided in the gripper 10 to enhance the flexibility of the gripper 10 while preserving the structural integrity of the gripper 10.

The illustrated gripper 10 in FIG. 4 has an arcuate shape with opposite ends and with numerous circumferentially extending rows of teeth 12. The only interruption of the teeth are the two spaced apart slots 14 formed in the gripper 10 which are equally spaced from the adjacent slot and an adjacent end of the gripper 10. In addition, the teeth 12 are interrupted by a circumferential groove 16 in which a spring 38 or like clip is inserted to retain the gripper 10 on a plug.

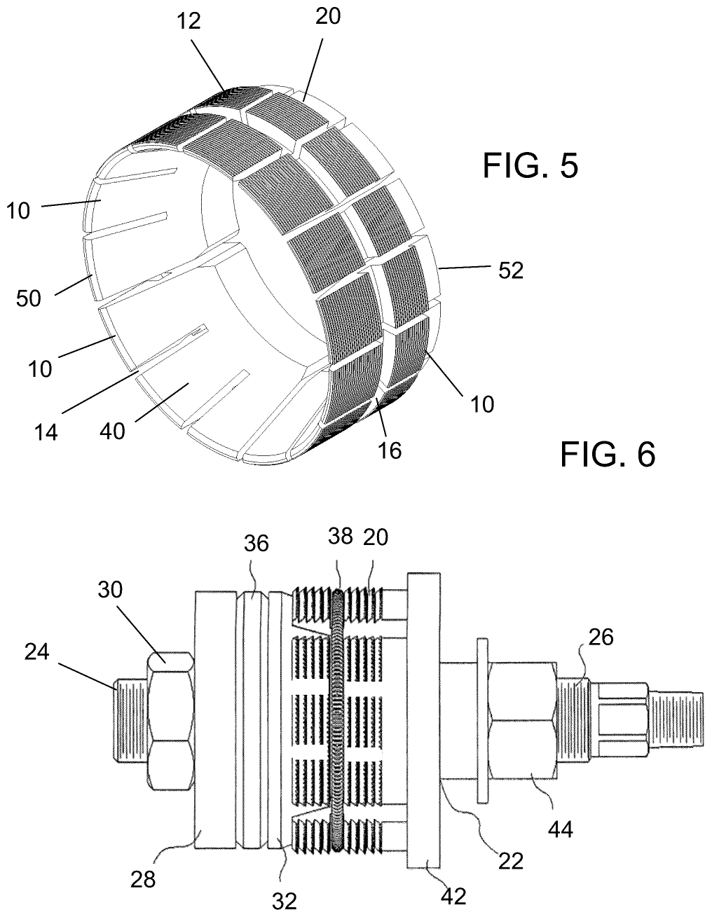

As best shown in FIG. 5, each gripper 10 includes a distal end 50 and a proximate end 52. The circumferential groove 16 extends about midway between the distal and proximal ends, 50 and 52. The distal end 50 has a tapered inner wall 40 for confronting a camming surface of a plug. The slot 14 extends completely through the gripper 10 where it extends from the distal end 50 to about the circumferential groove 16. In contrast, the slots 14 extend into but not entirely through the grippers 10 as the slot 14 extends from the circumferential groove 16 to the proximal end 52. At this location, the slot 14 extends through the teeth 12 but not entirely through the full depth of the gripper 10. See FIG. 5.

The uniformity of the teeth profile is critically important for controlling the depth of penetration (which result in gripper marks). Some conventional plugs utilize abrasive grids which are deposited onto a gripper surface using plasma spray. The downside of this approach is the lack of precision control over the surface condition, leading to the creation of high and low spikes, which in turn results in an uncontrollable penetration depth into the pipe's internal diameter. In contrast, the low-marking grippers 10 as shown in FIGS. 3-5 offer superior control over surface profile, ensuring precise control over the depth of the gripping marks, which according to embodiments may range from only 0.002 inch to 0.005 inch (about 50.8 μm to about 127 μm).

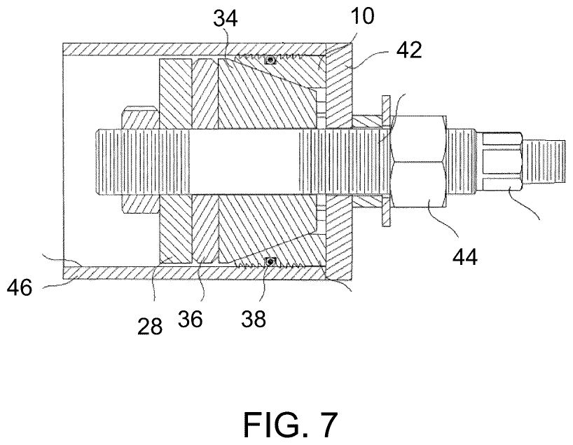

As shown in FIG. 5, a set 20 of separate grippers 10 can be aligned radially to produce a circular or ring-shaped array of teeth 12 for confronting an inner diameter of a pipe. By way of example, FIGS. 1, 2, 6 and 7 show a plug 22 on which the set 20 of grippers 10 may be mounted. The plug 22 includes a distal end 24 of a shaft 26 which is inserted into a pipe during use. In FIGS. 6 and 7, a distal end plate 28 abuts a locking nut 30; in FIGS. 1 and 2, the distal end plate 28 is connected directly to the shaft 26 or is formed integrally with the shaft 26. An end 32 of a camming element 34 faces the distal end plate 28 with a sealing element 36 sandwiched therebetween.

As best shown in FIG. 7, the camming element 34 has a sloping outer surface providing a frustoconical shape. The grippers 10 have a corresponding taper surface 40 which is supported on the camming element 34. A spring, clip or the like 38 retains the set 20 of grippers 10 on the camming element 34. The plug 22 includes a proximal end plate 42 which abuts against a proximal end of the grippers 10. One or more nuts 44 located exterior of the pipe can be used to cause the distal and proximal end plates, 28 and 42, to move closer together or further apart.

When the plug 22 is in the configuration as shown in FIGS. 1, 2 and 6, the plug 22 may be inserted into the end of a pipe 46 shown in FIG. 7 in which the proximal end plate abuts the end of the pipe 46. Thereafter, the one or more nuts 44 can be threaded further onto the shaft 26 or other fastener to urge the distal end plate 28 toward the proximal end plate 42. As this occurs, the camming element 34 and sealing element 36 also advance toward the proximal end plate 42. In turn, this causes the set 20 of grippers 10 to be pushed radially outward by the camming action provided by the camming element 34 and into contact with the inner diameter of the pipe 46. As the plug is further compressed together, the grippers 10 tightly grip the inner diameter of the pipe 46 which prevents further movement of the camming element 34. Thus, as the distal end plate 28 advances toward the now stationary camming element 34, the elastic sealing element 36 is compressed and extends radially outward into sealing engagement with the inner diameter of the pipe 46.

The plug 22 using the grippers 10 provides improvements in performance and safety. Despite reducing markings on the pipe wall (i.e., and potentially damaging the pipe), safety and operational performance remains.

The condition of the pipe ID plays a particularly important role in securing the plug during testing. However, maintaining the pipe condition can sometimes be challenging due to factors such as weather, debris, dust, residual process media, corrosion, and the like. Typically, it is specified that the pipe ID should be cleaned and free from lubricants, rust, residual chemicals, etc., when installing a test plug. Additionally, the grippers should be cleaned of any residual chemicals from previous tests.

To simulate a potential worst-case condition, the grippers 10 of the plug 22 shown in FIG. 9 were covered in a heavy layer of grease and applied to the pipe as shown in FIG. 8. Applying grease (i.e., the white residue) to the grippers 10 and pipe ID represents the most challenging condition. This qualification test with grease applied on pipe ID and grippers was conducted to confirm the performance of the plug 22 having low-marking grippers 10 as described above (i.e., plugs expected to be branded as GT Flex test plugs or GTX test plugs by Applicant) under the most difficult conditions. This ensures the highest safety factor when using these plugs in the field.

As a result of the qualification testing with grease applied on pipe ID and grippers, the plug exceeded expectations. Not only did it hold the full line pressure, but it also did not move at all to secure its grip. Further, only minute markings were formed in the pipe 46. See FIGS. 8 and 12.

FIG. 10 shows the results of qualification testing with grease applied on pipe ID and grippers using a test plug having the grippers 10 and FIG. 11 shows results for a test plug having conventional grippers. The y-axis is depth of the penetration (nm) into the pipe wall and the x-axis is test pressure (psi). As shown in FIG. 10, the grippers 10 left markings that were only of a depth of about 0.0034 inch (86 μm). See FIG. 12 which provides an image of the markings. In contrast, the marking left by a conventional gripper were of a depth of about 0.0118 inch (300 μm) and even about 0.0136 inch (346 μm) qualification tested under the same conditions. See FIG. 13 providing an image of the markings of the conventional plugs. A visual comparison of FIGS. 12 and 13 readily shows the difference in markings.

The foregoing description and specific embodiments are merely illustrative of the principles thereof, and various modifications and additions may be made to the apparatus by those skilled in the art, without departing from the spirit and scope of this invention.

1. A gripper for a test or isolation plug, comprising a gripper segment having a pipe or tube confronting surface with a plurality of separate rows of gripper teeth longitudinally-spaced apart on said surface, each of the separate rows of gripper teeth comprising an alternating array of individual tips and gaps such that each row is serrated along its length, each of the teeth having a height of 0.005 inch or less, and the gripper segment including at least one longitudinal-extending slot extending therethrough.

2. The gripper according to claim 1, wherein a tip of each tooth has an area of less than 0.0002 inch².

3. The gripper according to claim 2, wherein said gripper comprises a plurality of said gripper segments adapted for alignment relative to a pipe or tube.

4. The gripper according to claim 3, wherein each of said gripper segments is an arc-shaped segment and has at least two evenly spaced apart longitudinally-extending slots.

5. The gripper according to claim 4, wherein said plurality of said gripper segments are disposed in an annular alignment.

6. The gripper according to claim 5, wherein said plurality of said gripper segments are interconnected by a spring clip.

7. The gripper according to claim 2, wherein each of said teeth may be provided in a generally truncated pyramidal shape having tapered walls and a flat tip.

8. The gripper according to claim 7, wherein the gripper segment includes an opposite camming surface that is tapered in the longitudinal direction.

9. The gripper according to claim 1, wherein the gripper segment includes a recess in said surface for receiving a spring clip.

10. The gripper according to claim 1, wherein the gripper segment is made of metal, a ceramic material, or plastic.

11. A hydrostatic test or isolation plug, comprising:
a plug body extending along a longitudinal axis;
at least one elastic seal carried on said plug body; and
a plurality of gripper segments aligned in an assembly on said plug body, each of said gripper segments having a pipe or tube confronting surface with a plurality of separate rows of gripper teeth longitudinally-spaced apart on said surface,
each of the separate rows of gripper teeth comprising an alternating array of individual tips and gaps such that each row is serrated along its length;
each of the teeth having a height of 0.005 inch or less; and
each of the gripper segments including at least one longitudinal-extending slot extending therethrough.

12. The hydrostatic test or isolation plug according to claim 11, wherein a tip of each tooth has an area of less than 0.0002 inch².

13. The hydrostatic test or isolation plug according to claim 12, wherein each of said gripper segments is an arc-shaped segment and has at least two evenly spaced apart longitudinally-extending slots.

14. The hydrostatic test or isolation plug according to claim 13, wherein said plurality of said gripper segments are disposed in an annular alignment.

15. The hydrostatic test or isolation plug according to claim 14, wherein said plurality of said gripper segments are interconnected by a spring clip.

16. The hydrostatic test or isolation plug according to claim 14, wherein each of said teeth has a pyramidal shape with a flattened top.

17. The hydrostatic test or isolation plug according to claim 14, further comprising compression end plates carried on said plug body on opposite axial sides of said annular seal, said compression end plates being movable toward and away from each other.

18. A pipe and hydrostatic test or isolation plug assembly, comprising:
a pipe or tube having an open end;
a plug body extending within or about the pipe or tube;
at least one annular elastic seal carried on said plug body and in sealing engagement with a wall of the pipe or tube; and
a plurality of gripper segments aligned in an assembly on said plug body, each of said gripper segments having a pipe or tube confronting surface with a plurality of separate rows of gripper teeth longitudinally-spaced apart on said surface;
each of the separate rows of gripper teeth comprising an alternating array of individual tips and gaps such that each row is serrated along its length;
each of the teeth having a height of 0.005 inch or less and a tip having an upper surface with an area of less than 0.0002 inch²; and
each of the gripper segments including at least one longitudinal-extending slot extending therethrough.
